(19) United States
(12) Patent Application Publication
(10) Pub. No.: US 2013/0298875 A1
(43) Pub. Date: Nov. 14, 2013

(54) METHOD FOR OPERATING A MOTOR VEHICLE

(71) Applicants: Laurent Nack, Stuttgart (DE); Ruediger Weiss, Moetzingen (DE); Lanouar Chouk, Guendelbach Vaihingen An Der Enz (DE)

(72) Inventors: Laurent Nack, Stuttgart (DE); Ruediger Weiss, Moetzingen (DE); Lanouar Chouk, Guendelbach Vaihingen An Der Enz (DE)

(21) Appl. No.: 13/880,574

(22) PCT Filed: Sep. 28, 2011
(86) PCT No.: PCT/EP2011/066885

§ 371 Date: Jun. 24, 2013

(30) Foreign Application Priority Data
Oct. 19, 2010 (DE) 10 2010 042 600.8

(51) Int. Cl. F02D 41/30

(52) U.S. Cl. CPC F02D 41/30
USPC 123/478

(57) ABSTRACT

A method for operating a motor vehicle having a hybrid drive which includes an internal combustion engine having an injection system and an electric motor, in which in an operating situation, in which the motor vehicle is driven by the electric motor and the internal combustion engine is turned off, a level of the fuel pressure in the injection system is increased by the electric motor to prepare a start of the internal combustion engine.

### FIELD

The present invention relates to a method and a system for operating a motor vehicle having a hybrid drive.

### BACKGROUND INFORMATION

Motor vehicles having a hybrid drive include an internal combustion engine and an electric motor which may be operatively linked to one another via a clutch assembly, so that the above-mentioned engine and motor are able to exchange power.

German Patent Application No. DE 100 02 132 A1 describes a method for controlling the drive torque of a diesel engine having a common-rail injection. In this case, a drive torque is temporarily supplied or withdrawn with the aid of an auxiliary generator for rapidly adjusting a new drive torque of the crankshaft of the internal combustion engine. To rapidly reduce the drive torque, an injection operation is stopped so that the auxiliary generator of the internal combustion engine provides the desirable reducing drive torque during the interruption of the injection operation, and so that the injection operation is continued when the pressure in the pressure accumulator has been reduced to the extent that it is low enough for the required injection quantity or the appropriate drive torque.

### SUMMARY

In one specific embodiment, a rail pressure build up and thus the fuel pressure build up take place in a storage device, usually a pressure accumulator, of an injection system (common rail), while a hybrid vehicle is driven in the electric mode. While driving in the electric mode, the hybrid vehicle is driven by an electric motor. While driving in the electric mode, a start, usually a cold start, of the internal combustion engine of the hybrid vehicle is prepared for an implementation of the present invention.

Accordingly, already during a purely electric cold start of the hybrid vehicle, before a start intention is requested from the internal combustion engine, the internal combustion engine is tow-started by the electric motor, usually an electric machine. In the case of an electric cold start, the hybrid vehicle starts in the purely electric mode and is driven by the electric machine, without starting the internal combustion engine for this purpose. However, this is only possible under certain conditions. For example, the outdoor temperature must be above an applicable threshold, e.g., 0° C. or 10° C. Moreover, other boundary conditions should be met such as a state of charge of the HV battery, a driver input, an acceleration pedal gradient, a brake booster pressure, etc.

During the above-described cold start, only the electric motor is in operation and the internal combustion engine is turned off. The internal combustion engine is tow-started by the electric motor until a high-pressure pump (HPP) has brought the pressure of the fuel, e.g., diesel, in the injection system, usually in the storage device of the injection system, to a desirable level. If the pressure has reached the desirable level, the pressure has at least a value which is required for a normal operation of the internal combustion engine. Later on, the start of the internal combustion engine may take place without delay due to the built-up, sufficiently high pressure.

It is, however, also possible that the internal combustion engine is turned off while the motor vehicle is being driven and the motor vehicle is driven only by the electric motor over a period of time; meanwhile, in one embodiment of the method, the internal combustion engine may be prepared for a restart if the fuel pressure should have decreased after the internal combustion engine has been turned off temporarily.

Usually, a particularly large quantity of fuel to be injected is required for a first cold start. Furthermore, a good preparation of the fuel may be necessary. For this purpose, the fuel must have an appropriately high injection pressure, the injection pressure depending on the pressure level in the storage device and thus on the rail pressure. This may mean that, in one embodiment of the present invention, the rail pressure is increased to a level which is required to carry out the first injection and, if necessary, at least one other subsequent injection. Here, the injection pressure may be higher for a start operation than the injection pressure for a normal continuous operation of the internal combustion engine. Accordingly, the rail pressure provided for the injection may also be higher than the rail pressure for a normal continuous operation.

The high-pressure pump (HPP) is usually driven by the internal combustion engine, typically by a camshaft. In this way, the pressure must be built up completely and to a particularly high level for the cold start; conventionally, this may only take place when the internal combustion engine is rotating. A cold start in the electric mode and a cold start of the internal combustion engine while driving are not possible under this condition. Due to a long start time of the internal combustion engine, this may lead to jolts, since a drive torque is not present or present only insufficiently.

If the pressure is built up within the scope of the present invention even prior to a start intention of the internal combustion engine, the start time may be reduced to a minimum. Thus, a robust cold start of the internal combustion engine is possible without comfort losses during the driving in the electric mode.

In the case of a cold start, the motor vehicle starts in the electric mode, the vehicle being driven solely by the electric motor or the electric machine. To prepare the internal combustion engine for the start, it is tow-started by the electric motor. This usually takes place in an operating mode in which no or very little torque, usually a drive torque, is requested for the drive. During this phase, the high-pressure pump of the injection system designed to adjust the pressure is connected to at least one clutch module and is controlled via the at least one clutch module, which, in turn, is driven by the electric motor, to increase the fuel pressure in the storage device (rail). If the pressure reaches a threshold which is greater than or equal to a value of a pressure required for the injection release of the internal combustion engine and which is a function of an instantaneous temperature of the internal combustion engine, among other things, the internal combustion engine may be started with the first injection. Subsequently, the at least one clutch module between the electric motor and the injection system and thus also the electric motor and the internal combustion engine are reopened. The at least one clutch module is designed as a clutch assembly and/or a clutch. If, for example, the start of the internal combustion engine is requested due to a high torque demand, the internal combustion engine may be started rapidly, robustly, and under a most constant possible boundary condition.

If, after a pressure build-up, usually after the first build-up, a very long time period elapses without a start intention of the internal combustion engine, it is possible in one embodiment of the present invention to again reduce the built-up rail pressure via a leakage induced in a targeted manner within the injection system by activating a pressure control valve as the leakage device. It is, however, possible to regularly tow-start the internal combustion engine to maintain the pressure on a sufficiently high level. For this purpose, time intervals may be defined which are a function of operating parameters, e.g., pressure, a pressure change over time, the temperature, or a time period which is necessary to change and/or build up the pressure. If such a time interval has elapsed after reaching a sufficiently high pressure, the pressure may be reduced again.

According to one implementation of the present invention, driving in the electric mode, driven only by the electric motor, is released only after the first start, usually a cold start, of the internal combustion engine and thus terminated when certain conditions are met, such as in the case of a sufficiently high temperature of the internal combustion engine and/or as soon as a rail pressure of an injection system of the internal combustion engine has reached an operating pressure. As soon as a release of the electric motor takes place, the internal combustion engine is also used to drive the motor vehicle.

Adjusting the rail pressure to an intermediate level, which is lower than the level for a normal start, e.g., a cold start, of the internal combustion engine, is possible. However, as soon as the intention for the start is present, the pressure may be increased within a short period of time from the intermediate level to the level suitable for the first injection.

An example system according to the present invention is designed to carry out all steps of the presented method. Individual steps of this method may also be carried out by individual components of this system. Furthermore, functions of the system or functions of individual components of the system may be implemented as steps of the method. In addition, it is possible to implement the steps of this method as functions of at least one component of the system or of the entire system.

Further advantages and embodiments of the present invention result from the description and the figure.

It is understood that the above-mentioned features and the features to be explained below are usable not only in the given combination, but also in other combinations or alone without departing from the scope of the present invention.

### BRIEF DESCRIPTION OF THE DRAWING

FIG. 1 shows in schematic representation a hybrid vehicle, which has a specific embodiment of a system according to the present invention, in a specific embodiment of the method according to the present invention.

### DETAILED DESCRIPTION OF EXAMPLE EMBODIMENTS

The present invention is represented schematically in the FIGURE on the basis of one specific example embodiment and is described in greater detail below with reference to the FIGURE.

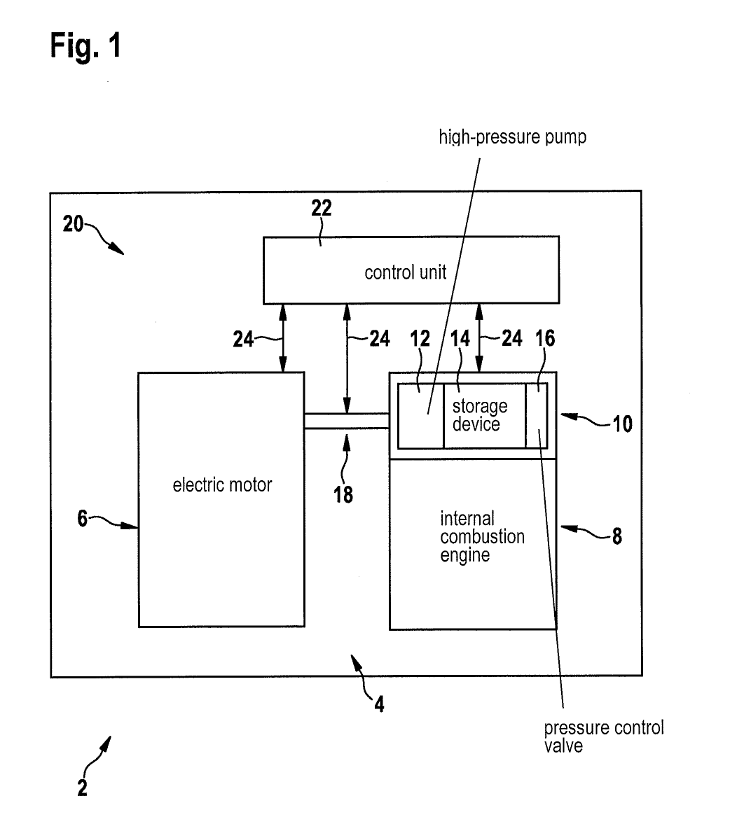

FIG. 1 shows in schematic representation a motor vehicle 2 which is designed as a hybrid vehicle and which has a hybrid drive 4 which, in turn, includes an electric motor 6 and an internal combustion engine 8. Furthermore, internal combustion engine 8 includes an injection system 10 which is designed to inject fuel under pressure into combustion chambers of internal combustion engine 8 so that the fuel may be ignited in the combustion chambers. As components, injection system 10 includes a high-pressure pump 12, a storage device 14 for storing fuel, as well as a pressure control valve 16 as the leakage device. During a conventional operation of internal combustion engine 8, fuel within storage device 14 is brought to a pressure suitable for operation using high-pressure pump 12. If the pressure within storage device 14 becomes too high, it is possible to discharge fuel from storage device 14 by activating pressure control valve 16, thus inducing a leakage, and to reduce the pressure again.

Electric motor 6 and internal combustion engine 8 may be coupled to one another via at least one clutch module 18 as the other component of hybrid drive 4, so that the at least one clutch module 18 assumes the function of a clutch between at least one component of electric motor 6 and at least one component of injection system 10 and/or thus also at least one component of internal combustion engine 8. Depending on whether a clutch between electric motor 6 and internal combustion engine 8, which is provided by the at least one clutch module 18, is disengaged or engaged, it is thus possible to provide an interaction between electric motor 6 and internal combustion engine 8 via the at least one clutch module, thus enabling an exchange of drive torque and/or power between electric motor 6 and internal combustion engine 8.

Motor vehicle 2 also includes a specific example embodiment of a system 20 according to the present invention which is also represented schematically in FIG. 1 and includes a control unit 22. This control unit 22 is connected via connections 24 to electric motor 6, the at least one clutch module 18, internal combustion engine 8 and injection system 10 having high-pressure pump 12, storage device 14 and pressure control valve 16 as the components of hybrid drive 4. Via connections 24, control unit 22 may detect operating parameters of the above-mentioned components of hybrid drive 4 and also control and/or regulate functions of these components of hybrid drive 4.

System 20 is designed to operate motor vehicle 2 having hybrid drive 4. In one operating situation in which motor vehicle 2 is driven by electric motor 6 and internal combustion engine 8 is turned off control unit 22 induces electric motor 6 to increase a level of the fuel pressure in injection system 10 to prepare a start of internal combustion engine 8.

The at least one clutch module 18, via which at least one component of injection system 10 interacts with electric motor 6, is engaged between electric motor 6 and internal combustion engine 8 to carry out the example method, so that electric motor 6 is connected to the at least one component, high-pressure pump 12 in the present case, and drives it.

To carry out the specific example embodiment of the method according to the present invention, explained with reference to FIG. 1, the at least one clutch module 18 may interact with a camshaft or a crankshaft of internal combustion engine 8 and thus drive the camshaft or the crankshaft. For this purpose, the at least one clutch module 18 is acted on and thus engaged starting from control unit 22 in such a way that an operative connection is provided between the at least one clutch module 18 and the camshaft or the crankshaft. The result is that high-pressure pump 12 of injection system 10 is driven starting from electric motor 6 via the at least one clutch module 18 and the camshaft or crankshaft, thus, in turn, resulting in a pressure increase of the fuel in storage device 14. The result of this interaction furthermore is that internal combustion engine 8 is tow-started by electric motor 6. This includes the measure that the pressure is adjusted to a level which is required to carry out the start of internal combustion engine 8.

In one embodiment, internal combustion engine 8 is started in the presence of a sufficiently high pressure and an intention to carry out the start, as a possible operating parameter. This procedure may also be controlled by control unit 22.

The initially built-up pressure may be reduced again if in the presence of an increased pressure, a time interval, defined and/or to be set, elapses until a start, an excessively high pressure being reduced via pressure control valve 16 of injection system 10. In one embodiment, it is possible that the pressure is adjusted to a suitable, sufficiently high intermediate level, which is lower than the level for a normal start, e.g., cold start, of internal combustion engine 8, with the aid of control unit 22 by alternatingly activating the at least one clutch module 18 and pressure control valve 16. However, as soon as the intention for the start is present, the pressure may be increased within a short period of time starting from the intermediate level to the level suitable for the first injection by activating the at least one clutch module 18.

1-10. (canceled)

11. A method for operating a motor vehicle having a hybrid drive which includes an internal combustion engine having an injection system and an electric motor, the method comprising:
increasing, by the electric motor, a level of fuel pressure in the injection system to prepare a start of the internal combustion engine in an operating situation in which the motor vehicle is driven by the electric motor and the internal combustion engine is turned off.

12. The method as recited in claim 11, wherein the internal combustion engine is tow-started by the electric motor.

13. The method as recited in claim 11, wherein the pressure is adjusted to a level which is required to carry out the start of the internal combustion engine.

14. The method as recited in claim 11, wherein the fuel pressure is adjusted by a high-pressure pump of the injection system, and the high-pressure pump is driven by the electric motor.

15. The method as recited in claim 11, wherein at least one component of the internal combustion engine interacts with the electric motor, the at least one component being driven by at least one clutch module which is engaged between the electric motor and the internal combustion engine.

16. The method as recited in claim 11, wherein the pressure is adjusted to an intermediate level which is lower than a level for a normal start or cold start, the pressure being increased from the intermediate level to a level suitable for a first injection, as soon as an intention for a start is present.

17. The method as recited in claim 11, wherein the internal combustion engine is started in a presence of a sufficiently high pressure and an intention to carry out the start.

18. The method as recited in claim 11, wherein in a presence of an increased pressure, the pressure is reduced again if a defined time interval elapses until a start.

19. The method as recited in claim 11, wherein an excessively high fuel pressure is reduced with the aid of a leakage device of the injection system.

20. A system for operating a motor vehicle having a hybrid drive which includes an internal combustion engine having an injection system and an electric motor, in which in an operating situation, the motor vehicle is driven by the electric motor and the internal combustion engine is turned off, the system comprising:
a control unit which induces a level of fuel pressure in the injection system to be increased by the electric motor to prepare a start of the internal combustion engine.
